(19) United States
(12) Patent Application Publication
(10) Pub. No.: US 2026/0316040 A1
(43) Pub. Date: Oct. 15, 2026

(54) A MICROFLUIDIC MODULE FOR A PHOTOCHEMICAL REACTOR

(71) Applicant: SIGNIFY HOLDING B.V., EINDHOVEN (NL)

(72) Inventors: ANNA WILHELMINA MARIA DE BEST, VELDHOVEN (NL); SILVIA MARIA BOOIJ, EINDHOVEN (NL); NORBERTUS ANTONIUS MARIA SWEEGERS, LIEROP (NL)

(21) Appl. No.: 19/116,516

(22) PCT Filed: Sep. 20, 2023
(86) PCT No.: PCT/EP2023/075897

§ 371 Date: Mar. 28, 2025

(30) Foreign Application Priority Data
Sep. 29, 2022 (EP) 22198609.4

(51) Int. Cl. B01J 19/00; B01J 19/12

(52) U.S. Cl. CPC B01J 19/0093; B01J 19/12; B01J 2219/00783; B01J 2219/00822; B01J 2219/00824; B01J 2219/00831; B01J 2219/00849; B01J 2219/00855; B01J 2219/00873; B01J 2219/00934

(57) ABSTRACT

A microfluidic module (1) for a photochemical reactor (20), the module (1) comprising a layered structure comprising a first layer (2), a second layer (3) and a third layer (4), the second layer (3) being arranged between the first layer (2) and the third layer (4). At least one of the first layer (2) and the third layer (4) is transmissive to light used for triggering a photochemical reaction in the process fluid flow. The second layer (3) comprises a channel (5) configured to, in operation, lead a process fluid flow comprising a chemical reactant from an inlet end (11) of the channel to an outlet end (12) of the channel (5), the channel (5) extending in the second layer (3) in a predetermined pattern. The channel (5) comprises a plurality of channel segments (51-58), and the second layer (3) comprises at least one scattering element (9) arranged between the plurality of channel segments (51-58) of the channel (5). The scattering element (9) is configured to scatter light used for triggering a photochemical reaction in the process fluid flow.

### FIELD OF THE INVENTION

The invention relates to a microfluidic module for a photochemical reactor, the module comprising a first layer, a second layer and a third layer, the second layer being sandwiched between the first layer and the third layer, and the second layer comprising a channel configured to, in operation, lead a fluid flow comprising a chemical reactant from an inlet end of the channel to an outlet end of the channel.

### BACKGROUND OF THE INVENTION

In photochemical reactors photons are used to initiate a chemical reaction. The reaction rate is limited by the penetration of the light in the liquid containing the chemical reactants, and by the refreshment rate of the chemicals. Parallel plate reactors offer the advantage of a large ratio of surface area versus volume. Refreshment of the reaction liquid at the surface is enhanced by turbulent flow in the meandering channels of the microflow modules.

Commercial microflow modules are manufactured by, for instance, the companies Chemtrix and Corning. These microflow modules consist of multiple plates stacked in a setup, where a light engine illuminates one or multiple plates.

US 2018/0071709 A1 discloses a flow reactor with a flow passage and a light diffusing rod arranged inside and along the flow passage. The diffusing rod may include scattering nanostructures. The diffusing rod may be surrounded radially by a coating or sheath, which may include scattering structures or materials.

In photochemical reactors, the fluidic module is a stack of transparent glass sheet material. A cross-sectional view of a schematic example of a prior art fluidic module 101 is shown in FIG. 1. The first sheet 102 is flat, the second sheet 103 has a channel 105 with meandering slits, and the third sheet 104 is flat. The sheets are jointed together in such a way that a pressure of 20 bar can be applied. As a consequence, the distance between neighboring channel segments is rather large. Effectively less than 50% of the cross-sectional surface area of the second sheet 103 is occupied by the reaction fluid.

The light engine used in the reactors may consist of an array of LEDs on a PCB. The LEDs have a Lambertian intensity distribution. As is illustrated on FIG. 2, the LEDs 106 together give a uniform irradiance 107 at the second sheet 103 with the meandering channel 105. This prevents local peak irradiance that could lead to unwanted effects, but unfortunately more than 50% of the light 108 passes the transparent material in between the channels 105 and leave the second sheet 103 of the fluidic module 101 at the opposite side without interaction with the reaction fluid.

Therefore, there is a desire to provide a microfluidic module for a photochemical reactor, which microfluidic module is improved such as to enable an increased efficiency of the photochemical reactor.

### SUMMARY OF THE INVENTION

It is an object of the present invention to overcome this problem, and to provide a microfluidic module for a photochemical reactor, which microfluidic module is improved such as to enable an increased efficiency of the photochemical reactor.

According to a first aspect of the invention, this and other objects are achieved by means of a microfluidic module for a photochemical reactor, the module comprising a layered structure comprising a first layer, a second layer and a third layer, the second layer being arranged between the first layer and the third layer, where the second layer comprises a channel configured to, in operation, lead a process fluid flow comprising a chemical reactant from an inlet end of the channel to an outlet end of the channel, the channel extending in the second layer in a predetermined pattern, where at least one of the first layer and the third layer is transmissive to light used for triggering a photochemical reaction in the process fluid flow, where the channel comprises a plurality of channel segments, and where the second layer further comprises at least one scattering element arranged between the plurality of channel segments, the at least one scattering element being configured to scatter light used for triggering a photochemical reaction in the process fluid flow.

Thereby, and especially by providing that the channel comprises a plurality of channel segments, and in particular that the second layer further comprises at least one scattering element arranged between the plurality of channel segments, the at least one scattering element being configured to scatter light used for triggering a photochemical reaction in the process fluid flow, a microfluidic module for a photochemical reactor is provided with which light which may otherwise have passed through the second layer without activating the chemical reactant flowing in the channel is scattered and may thereby be directed back towards the channel by the scattering element. Thereby, less light is lost, and more light is exploited for activating the chemical reactant. Thereby the microfluidic module is improved such as to enable an increased efficiency of a photochemical reactor in which the microfluidic module is used.

Further, by providing that the second layer comprises at least one scattering element arranged between the plurality of channel segments, the desired scattering effect is obtained without reducing the volume of the channel and thereby without influencing the liquid flow through the channel. This in turn provides for a further enhanced efficiency of a photochemical reactor in which the microfluidic module is used.

In an embodiment, the at least one scattering element is arranged in the part or parts of the second layer arranged between the plurality of channel segments.

Thereby, a microfluidic module with a particularly simple structure is provided for.

In an embodiment, the at least one scattering element is arranged on or adjacent to at least one surface of the second layer facing a channel segment.

Thereby, it is ensured that more light is scattered and thus refracted into the channel, thus providing for a microfluidic module with a particularly efficient scattering, which in turn provides for a particularly improved efficiency of the photochemical reactor in which the microfluidic module is used.

In an embodiment, the at least one scattering element is arranged on or adjacent to a surface of the second layer facing one or both of the first layer and the third layer.

Thereby, a microfluidic module with both an efficient scattering and a simple structure is provided for.

In an embodiment, the at least one scattering element is or comprises a material comprising a refractive index being different from the refractive index of the first layer.

Thereby, a particularly simple scattering element is provided for.

In an embodiment, at least one scattering element is or comprises a material comprising a refractive index being different from the refractive index of the first layer by at least 0.2, at least 0.3 or at least 0.5.

Such differences in refractive index have been shown to provide a particularly efficient scattering and thus a particularly improved efficiency of the photochemical reactor in which the microfluidic module is used.

In an embodiment, the at least one scattering element is provided as irregularities in the part or parts of the second layer arranged adjacent to a channel segment or between the plurality of channel segments.

Thereby, a microfluidic module in which the second layer may be made entirely of one of the same material is provided for. Such a microfluidic module is particularly simple and cost efficient to produce.

In an embodiment, the irregularities extend in a direction being parallel with a neighboring channel segment of the plurality of channel segments.

Such an orientation of the irregularities have been shown to provide a particularly efficient scattering and thus a particularly improved efficiency of the photochemical reactor in which the microfluidic module is used.

In an embodiment, the irregularities are made of a material being different from the material of the surrounding part or parts of the second layer arranged between the plurality of channel segments or are added as a diffusor material being one or more of a transparent material with micro-porosity and a transparent material with microcracks.

In an embodiment, the irregularities are (micro)pores, or (micro)cracks in the transparent material of the second layer.

Thereby, a further improvement of the scattering efficiency and thus a further improvement of the efficiency of the photochemical reactor in which the microfluidic module is used may be obtained.

In an embodiment, the irregularities are scratches, tracks or lines.

Such irregularities are particularly simple in structure, and therefore particularly simple and cost efficient to produce.

In an embodiment, the at least one scattering element is made of a transparent material containing small particles of a different material such as such as phosphors, metals, or transparent materials with a refractive index that differs from the transparent matrix material. By small is in this context understood that the maximum diameter of the particles is larger than the wavelength of the light that triggers the chemical reaction, and smaller than the minimum dimension of the second layer, or that the diameter of the particles is between 0.5 micrometer and 100 micrometer. Further examples of suitable materials for such small particles include white particles, Titanium-dioxide (TiO₂), Zinc-oxide (ZnO), and semiconductor materials.

Such scattering materials have been shown to provide a particularly efficient scattering and thus a particularly improved efficiency of the photochemical reactor in which the microfluidic module is used.

Particles being larger than the wavelength of the light that is used to trigger the photochemical reaction are large enough to affect the direction of light rays with this specific wavelength. Together with the concentration, the particle size (distribution) determines the free path length of the light within the material (the average length that the light can travel without having an interaction with a phosphor particle). The particle size distribution and density should be chosen such that the free path length is (much) less than the thickness of the material.

Transparent particles with a different refractive index than the matrix material bend the light rays in a different direction. “White” and metallic particles reflect the rays and thus also change the direction of the rays. Phosphor particles absorb light with a specific wavelength, and convert that to a longer wavelength, at the cost of the Stokes' shift. The converted light is emitted in all directions, so in general with phosphors less interactions are required to obtain a certain degree of diffusivity.

In an embodiment, the part or parts of the second layer arranged between the plurality of channel segments are made of an optically transparent material on which the scattering element is arranged.

The optically transparent material may be glass.

Thereby, a microfluidic module with a particularly simple structure is provided for.

The predetermined pattern may be any one of a meandering pattern and a zig-zag pattern.

One or both of the first layer and the third layer may be made of an optically transparent material, such as a glass material.

The invention further relates to a photochemical reactor comprising at least one microfluidic module according to the invention.

In an embodiment, the photochemical reactor comprises a stack of microfluidic modules according to the invention.

In an embodiment, the photochemical reactor comprises a fluid with at least one chemical reactant, the fluid being provided in the channel of the microfluidic module or in the channels of the respective microfluidic modules of the stack of microfluidic modules.

In an embodiment, the photochemical reactor comprises one or more light engine configured to, in operation, emit light for activating the at least one chemical reactant.

In an embodiment, the photochemical reactor comprises one or more cooling plates configured to provide cooling to the one or more light engines.

In an embodiment, the photochemical reactor comprises a housing. In an embodiment, the photochemical reactor comprises a supporting element configured for resting on the ground.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 shows a cross-sectional side view of a prior art microfluidic module for a photochemical reactor.

FIG. 2 shows a ray trace diagram of the prior art microfluidic module of FIG. 1 when illuminated by a plurality of light engines.

FIG. 3 shows a cross-sectional side view of an embodiment of a microfluidic module according to the invention for a photochemical reactor.

FIG. 4 shows a cross sectional top view of the microfluidic module of FIG. 3.

FIG. 5 shows a ray trace diagram of the microfluidic module of FIG. 3 when illuminated by a plurality of light engines.

FIG. 6 shows a cross-sectional view of another embodiment of a microfluidic module according to the invention for a photochemical reactor.

FIG. 7 shows a perspective view of a photochemical reactor comprising a plurality of microfluidic modules according to the invention.

FIG. 8 shows a perspective view of a section of a photochemical reactor comprising a plurality of microfluidic modules according to the invention.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

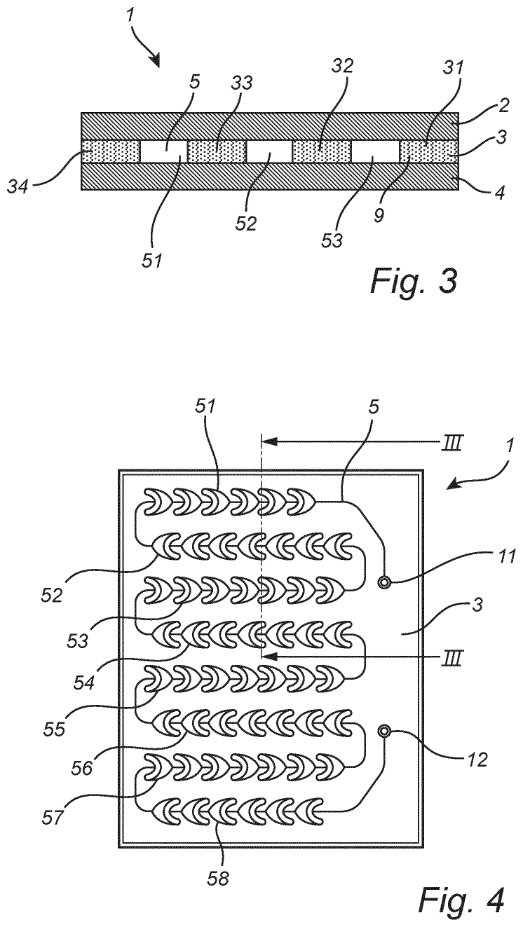

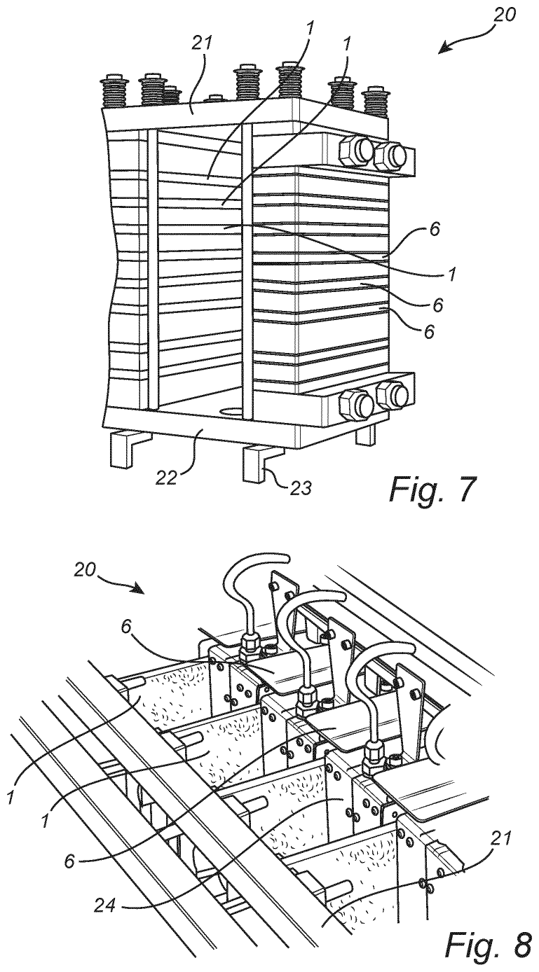

FIG. 3 shows a cross-sectional side view of an embodiment of a microfluidic module 1 according to the invention for a photochemical reactor 20 (cf. FIGS. 7 and 8). FIG. 4 shows a cross sectional top view of the microfluidic module 1, where the cross sectional view of FIG. 3 is taken along the line III-III in FIG. 4.

Generally, and irrespective of the embodiment, the microfluidic module 1 comprises a layered structure comprising a first layer 2, a second layer 3 and a third layer 4, where the second layer 3 is arranged between the first layer 2 and the third layer 4. The second layer 3 may for instance be stacked or sandwiched between the first layer 2 and the third layer 4.

The second layer 3 comprises a channel 5. FIG. 4 illustrates an exemplary embodiment of such a channel 5. The channel 5 is configured to, in operation, lead a process fluid flow comprising a chemical reactant from an inlet end 11 of the channel 5 to an outlet end 12 of the channel 5. The channel 5 extends in the second layer 3 in a predetermined pattern. The pattern of the channel 5 shown in FIG. 4 is a meandering pattern which is known per se in the art. Other feasible patterns of a channel 5 include, but are not limited to, a zig-zag pattern and a pattern extending back and forth between opposite outer sides of the second layer 3. As shown on FIG. 4, the channel 5 comprises a plurality of channel segments 51-58. Of these segments, three segments 51, 52 and 53 are visible on the cross-sectional view of FIG. 3.

To allow light used for triggering a photochemical reaction in the process fluid flow to reach the channel 5 and thus the process fluid flow flowing in the channel 5, one or both of the first layer 2 and the third layer 4 is transmissive to the light used for triggering a photochemical reaction in the process fluid flow, that is to trigger the chemical reactant.

Generally, and irrespective of the embodiment, the second layer 3 further comprises at least one scattering element 9 arranged between the plurality of channel segments 51-53. More particularly, the at least one scattering element 9 is arranged in the part or parts 31, 32, 33, 34 of the second layer 3 arranged between the channel segments 51, 52, 53. The at least one scattering element 9 is configured to scatter light used for triggering a photochemical reaction in the process fluid flow, that is to trigger the chemical reactant.

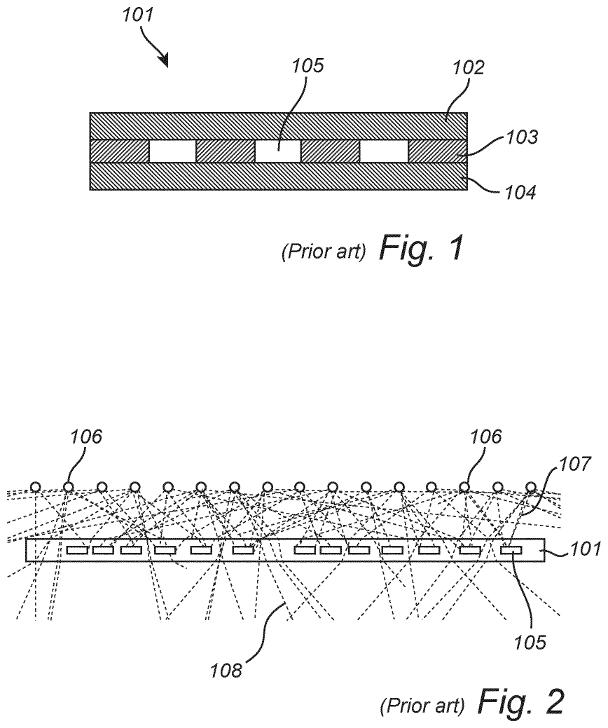

In the embodiment shown in FIG. 1, the scattering element 9 is provided in the form of particles distributed throughout the material of the part or parts 31, 32, 33, 34 of the second layer 3 arranged between the channel segments 51, 52, 53. The particles may for instance be white particles, metallic particles, or phosphor particles, embedded in the transparent matrix material of the second layer 3.

The scattering element 9 may comprise particles of a transparent material with a refractive index being different from the refractive index of the second layer 2. The refractive index of the material of the at least one scattering element 9 may for instance be different from the refractive index of the second layer by at least 0.2, at least 0.3, at least 0.4 or at least 0.5.

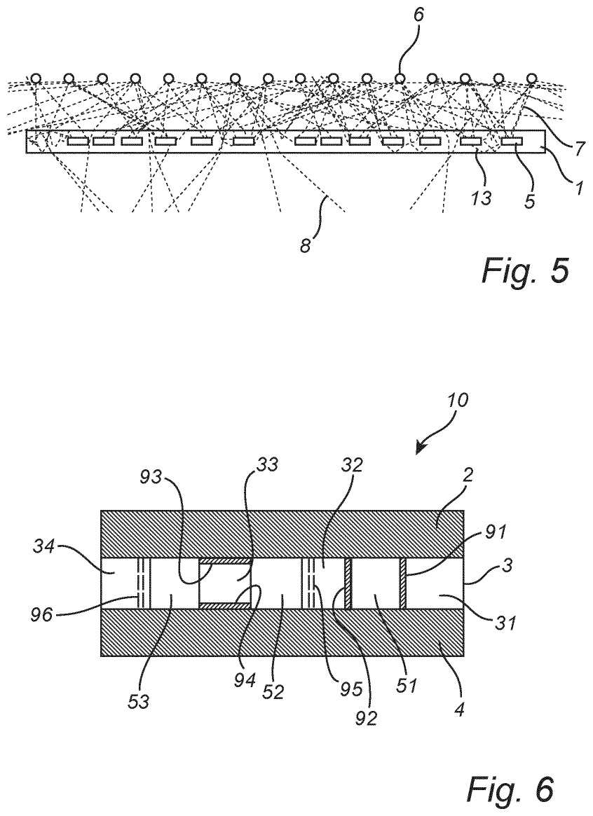

FIG. 5 shows a ray trace diagram illustrating the improved efficiency and lowered loss of activating light achieved with the microfluidic module 1 of FIGS. 3 and 4.

As may be seen, light 7 is emitted by the plurality or array of light engines 6, here in the form of LEDs, towards the microfluidic module 1, and thus towards the channel 5 and the fluid with the chemical reactant to be activated. Light rays that do not hit the channel 5 directly are refracted in the parts 31-34 of the second layer 3 in between the channel segments of the channel 5. Some of the refracted rays 13 are thereby caused to hit a side surface of a channel segment of the channel 5. Thereby fewer rays 8 are passing through the second layer 3 without hitting the channel 5. This in turn increases the efficiency of the module 1 and thereby the photochemical reactor 20.

FIG. 6 shows a cross-sectional view of another embodiment of a microfluidic module 10 according to the invention for a photochemical reactor 20. The microfluidic module 10 differs from that described above in relation to FIGS. 3 and 4 only in virtue of the arrangement of the scattering element 9. Different feasible arrangements of the scattering element 9 is shown on FIG. 6, cf. scattering elements 91-96. Microfluidic modules 10 with any one or more of the illustrated arrangements of the scattering element 91-96 may be envisaged.

On each side of the channel segment 51, or in other words in the parts 31 and 32 of the second layer 3, it is shown that the scattering elements 91 and 92 are arranged on a surface of the second layer 3 facing the channel segment 51. The scattering elements 91, 92 may also be arranged adjacent to a surface of the second layer 3 facing the channel segment 51. The scattering elements 91, 92 may also be arranged both on and adjacent to a surface of the second layer 3 facing the channel segment 51. Still further it is also possible to provide only one of the scattering elements 91 and 92.

In the part 33 of the second layer 3, it is shown that the scattering elements 93 and 94 are arranged adjacent to a surface of the second layer 3 facing the first layer 2 and adjacent to a surface of the second layer 3 facing the third layer 4. The scattering elements 93, 94 may also be arranged on a surface of the second layer 3 facing the first layer 2 and on a surface of the second layer 3 facing the third layer 4. The scattering elements 93, 94 may also be arranged both adjacent to and on a surface of the second layer 3 facing the first layer 2 and both adjacent to and on a surface of the second layer 3 facing the third layer 4. Still further it is also possible to provide only one of the scattering elements 93 and 94.

In the parts 32 and 34 of the second layer 3, it is shown that the scattering elements 95 and 96 are provided as irregularities provided in the parts 32 and 34 of the second layer 3. The scattering elements 95, 96 may be arranged adjacent to a channel segment of the channel 5. The scattering elements 95, 96 may also be arranged between the plurality of channel segments of the channel 5. Scattering elements 95, 96 in the form of such irregularities may be provided throughout the parts 32 and 34 of the second layer 3, or in only some sections of the parts 32 and 34 of the second layer 3. The scattering elements 95, 96 or irregularities extend generally in a direction being parallel with a neighboring channel segment 52, 53 of the plurality of channel segments of the channel 5. Suitable types of irregularities include irregularities made of a material being different from the material of the second layer 3, irregularities added as a diffusor material being one or more of a transparent material with micro-porosity and a transparent material with microcracks, and irregularities in the form of (micro)pores, (micro)scratches, tracks, and lines.

Generally, the scattering element(s) 9, 91-96 are a transparent material containing small particles of a different material, like a phosphor or combination of phosphors, glass, ceramic, metal, or semiconductor material. The particles comprise a diameter being larger than the wavelength of the light used to trigger a photochemical reaction in the process fluid flow. The transparent particles comprise a different refractive index than the refractive index of the material of the parts 31-34 of the second layer 3 arranged between the plurality of channel segments 51-58, Other suitable scattering element(s) are phosphors, white particles, Titanium-dioxide (TiO₂), Zinc-oxide (ZnO), and semiconductor materials.

Generally, and irrespective of the embodiment the first layer 2, second layer 3 and fourth layer 4 are made of an optically transparent material, such as a suitable glass material. The part or parts 31-34 of the second layer arranged between the plurality of channel segments 51-58 may be made of a glass material in which the scattering element(s) 9, 91-96 is embedded, a glass material on which the scattering element(s) 9, 91-96 is arranged or a combination thereof. The first layer 2 and the third layer 4 may be made of a suitable glass material.

Turning now to FIGS. 7 and 8, a photochemical reactor 20 is shown. Generally, the photochemical reactor 20 comprises at least one microfluidic module 1, 10 according to the present invention. More particularly, the photochemical reactor 20 comprises a stack of microfluidic modules 1, 10 according to the present invention.

The photochemical reactor 20 further comprises a fluid with at least one chemical reactant. The fluid being provided in the channel 5 of the microfluidic module 1, 10, or in the respective channel 5 of each microfluidic module 1, 10 of the stack of microfluidic modules 1, 10.

The photochemical reactor 20 further comprises one or more light engine 6. More particularly, the photochemical reactor 20 comprises an array of light engines 6. The light engine(s) 6 are configured to, in operation, provide light for activating the at least one chemical reactant. The light engine(s) 6 may be an array of LEDs. The array of LEDs may be arranged on a PCB. The array of LEDs may have a Lambertian intensity distribution. The light engine(s) 6 may, alternatively or additionally, be an array of laser light sources.

The photochemical reactor 20 may further comprise one or more cooling plates 24 (cf. FIG. 8). The cooling plates 24 provide cooling to the array of light engines 6. The cooling plates 24 may comprise a channel system carrying a fluid or liquid coolant.

The photochemical reactor 20 may further comprise a housing 21, 22. The photochemical reactor 20 may further comprise a supporting arrangement 23 configured to rest on the ground. The supporting arrangement 23 may be feet (as is shown on FIG. 7) or wheels.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A microfluidic module for a photochemical reactor, the module comprising:
a layered structure comprising a first layer, a second layer and a third layer, the second layer being stacked between the first layer and the third layer, wherein
the second layer comprises a channel configured to, in operation, lead a process fluid flow comprising a chemical reactant from an inlet end of the channel to an outlet end of the channel, the channel extending in the second layer in a predetermined pattern, wherein the predetermined pattern is any one of a meandering pattern and a zig-zag pattern, wherein
at least one of the first layer and the third layer is made of an optically transparent material being transmissive to light used for triggering a photochemical reaction in the process fluid flow,
wherein the channel comprises a plurality of channel segments,
wherein the second layer further comprises at least one scattering element arranged between the plurality of channel segments, the at least one scattering element being configured to scatter light used for triggering a photochemical reaction in the process fluid flow, and
wherein the at least one scattering element is arranged in the part or parts of the second layer arranged between the plurality of channel segments.

2. A microfluidic module according to claim 1, wherein the at least one scattering element is arranged on or adjacent to at least one surface of the second layer facing a channel segment of the channel.

3. A microfluidic module according to claim 1, wherein the at least one scattering element is arranged on or adjacent to a surface of the second layer facing one or both of the first layer and the third layer.

4. A microfluidic module according to claim 1, wherein the at least one scattering element is or comprises a material comprising a refractive index being different from the refractive index of the second layer.

5. A microfluidic module according to claim 1, wherein the at least one scattering element is or comprises a material comprising a refractive index being different from the refractive index of the second layer by at least 0.2, at least 0.3 or at least 0.5.

6. A microfluidic module according to claim 1, wherein the at least one scattering element is provided as irregularities in the part or parts of the second layer arranged adjacent to a channel segment or between the plurality of channel segments.

7. A microfluidic module according to claim 6, wherein the irregularities extend in a direction being parallel with a neighboring channel segment of the plurality of channel segments.

8. A microfluidic module according to claim 6, wherein the irregularities are one or more of:
made of a material being different from the material of the surrounding part or parts of the second layer arranged between the plurality of channel segments,
added as a diffusor material being one or more of a transparent material with micro-porosity and a transparent material with microcracks,
scratches,
tracks, and
lines.

9. A microfluidic module according to claim 1, wherein the at least one scattering element is made of a transparent material containing particles of a different material chosen from the group comprising:
phosphors, glasses, ceramics, metals, and semiconductor materials,
wherein the maximum diameter of the particles is larger than the wavelength of the light that triggers the chemical reaction, and smaller than the minimum dimension of the second layer, or wherein the diameter of the particles is between 0.5 micrometer and 100 micrometer.

10. A microfluidic module according to claim 1, wherein the part or parts of the second layer arranged between the plurality of channel segments are made of an optically transparent material in which the scattering element is embedded or on which the scattering element is arranged.

11. (canceled)

12. A microfluidic module according to claim 1, wherein one or more of the first layer and the third layer are made of a glass.

13. A photochemical reactor comprising at least one microfluidic module according to claim 1.

14. The-photochemical reactor according to claim 13, and comprising one or more of:
a fluid with at least one chemical reactant, the fluid being provided in the channel of the microfluidic module,
one or more light engine configured to, in operation, providing light for activating the at least one chemical reactant, and
one or more cooling plates.

15. The photochemical reactor according to claim 14, wherein the light engine comprises an array of LEDs and/or an array of laser light sources.

16. The photochemical reactor according to claim 14, wherein the one or more light engines provide light being emitted towards the microfluidic module.
